(19) United States
(12) Patent Application Publication
(10) Pub. No.: US 2025/0348037 A1
(43) Pub. Date: Nov. 13, 2025

(54) CONVEYANCE DEVICE AND IMAGE FORMING APPARATUS

(71) Applicant: Konica Minolta, Inc., Tokyo (JP)

(72) Inventor: Yuji HAYASHI, Tokyo (JP)

(21) Appl. No.: 19/202,374

(22) Filed: May 8, 2025

(30) Foreign Application Priority Data
May 13, 2024 (JP) 2024-077896

(51) Int. Cl. G03G 15/00; G03G 21/20

(52) U.S. Cl. CPC G03G 15/6573; G03G 15/6579; G03G 21/203; G03G 2215/00683; G03G 2215/0417

(57) ABSTRACT

A conveyance device conveys a recording medium with an image fixed by a fixer and includes a first guide disposed on a downstream side of the fixer. The first guide includes a sheet metal, a resin sheet disposed over a conveyance face of the sheet metal, and a high-thermal-conductivity sheet disposed between the sheet metal and the resin sheet and having a higher thermal conductivity than a thermal conductivity of the sheet metal.

### CROSS REFERENCE TO RELATED APPLICATIONS

The present invention claims priority under 35 U.S.C. § 119 to Japanese Patent Application No. 2024-077896, filed on May 13, 2024, is incorporated herein by reference in its entirety.

### BACKGROUND OF THE INVENTION

### Technical Field

The present invention relates to a conveyance device and an image forming apparatus. In particular, the present invention relates to a conveyance device and so forth that can prevent dew condensation by suppressing the temperature increase of surrounding air after fixing even when the fixing temperature is increased, and as a result, can prevent transfer failure in double-sided printing.

### Description of Related Art

In general, in an electrophotographic image forming apparatus such as a copier or a printer, a toner image formed on an image bearing member is transferred onto a recording medium, and the transferred toner image is fixed by a fixing device, thereby forming an image. As the fixing device, for example, there is a device in which a recording medium is passed through between a heating roller and a pressure roller, and the recording medium is heated and pressurized at a nip thereof.

In such an image forming apparatus, a conveyance path for appropriately conveying a recording medium is formed. For example, a conveyance device is used that appropriately guides a recording medium onto which a toner image has been transferred to a nip of a fixing device and conveys the image-fixed recording medium.

Since the sheet that is the recording medium has a high temperature after the fixing, the sheet passing through the conveyance path of the conveyance device increases the temperature of a conveyance guide plate. After the sheet passes through the conveyance path, the heat of the conveyance guide plate is conducted to the air around the conveyance guide plate and the temperature of the air increases, but the conveyance guide plate is deprived of heat by the surroundings. Therefore, temperature difference occurs between the conveyance guide plate and the air, and dew condensation occurs on the face of the conveyance guide plate. There is a problem in that the dews adhere to a sheet conveyed next, and thus the transfer failure occurs in double-sided printing.

In order to moderate the temperature change of the conveyance guide plate, for example, Japanese Patent No. 2934532 discloses a technique in which a member made of high-density polyethylene having a low thermal conductivity is attached to the face of the conveyance guide plate.

However, when the fixing temperature is increased in order to improve image fixability, the sheet temperature increases, and dew condensation occurs between the air and the guide plate to which the member made of high-density polyethylene having a low thermal conductivity is attached. Therefore, the problem of the transfer failure still remains.

In addition, in order to prevent the occurrence of dew condensation, there is a method of providing a component such as a cooling fan for lowering the sheet temperature, other than the method of attaching the member made of high-density polyethylene having a low thermal conductivity. Furthermore, there is a method of making the member having a low thermal conductivity thick to moderate thermal conduction. However, it is difficult to adopt these methods due to space constraint.

### SUMMARY OF THE INVENTION

The present invention has been made in view of the above-mentioned problems and situations. An object of the present invention is to provide a conveyance device and an image forming apparatus that can prevent dew condensation by suppressing the temperature increase of surrounding air after fixing even when the fixing temperature is increased and can prevent transfer failure in double-sided printing.

In order to solve the above-described problems, the present inventor has investigated the cause of the above-described problems and the like. The present inventor has devised a configuration in which a first guide to convey a recording medium on a downstream side of a fixing section includes a resin sheet, a high-thermal-conductivity sheet having a higher thermal conductivity than that of a sheet metal, and the sheet metal in this order from a conveyance face side. Thus, it has been found that dew condensation on the conveyance face during conveyance of an image-fixed sheet can be prevented.

That is, the above-described problems to be solved by the present invention are solved by the following means.

To achieve at least one of the abovementioned objects, according to an aspect of the present invention, a conveyance device reflecting one aspect of the present invention conveys a recording medium with an image fixed by a fixer and includes a first guide disposed on a downstream side of the fixer and including:
a sheet metal;
a resin sheet disposed over a conveyance face of the sheet metal; and
a high-thermal-conductivity sheet disposed between the sheet metal and the resin sheet and having a higher thermal conductivity than a thermal conductivity of the sheet metal.

According to an aspect of the present invention, an image forming apparatus reflecting one aspect of the present invention includes:
an image former forming an image on a recording medium;
a fixer fixing the image on the recording medium; and
the conveyance device, the conveyance device conveying the recording medium with the image fixed.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: FIG. 1A is a schematic sectional view of a guide and a sheet in a case where the guide is formed of a sheet metal;

FIG. 1B is a schematic sectional view of the guide and the sheet in the case where the guide is formed of the sheet metal;

FIG. 2 is a schematic sectional view of the guide and the sheet in a case where a resin sheet having a thermal conductivity lower than that of the sheet metal is disposed on the conveyance face of the guide;

FIG. 3A is a schematic sectional view of a first guide and the sheet according to the present invention;

FIG. 3B is a schematic sectional view of the first guide and the sheet according to the present invention;

FIG. 4 is a schematic diagram illustrating the configuration of a conveyance device of the present invention;

FIG. 5 is a schematic sectional view of a second guide and the sheet according to the present invention;

FIG. 6 is a schematic sectional view of a third guide and the sheet according to the present invention; and

FIG. 7 is a schematic diagram illustrating the configuration of an image forming apparatus of the present invention.

### DETAILED DESCRIPTION

The above means of the present invention can provide a conveyance device and an image forming apparatus that can suppress the temperature increase of the surrounding air after fixing and prevent dew condensation even when the fixing temperature is increased and can prevent transfer failure in double-sided printing.

Although the realization mechanism or action mechanism of the effects of the present invention are not clear, the present inventor infers the mechanism as follows.

First, the occurrence mechanism of dew condensation will be described.

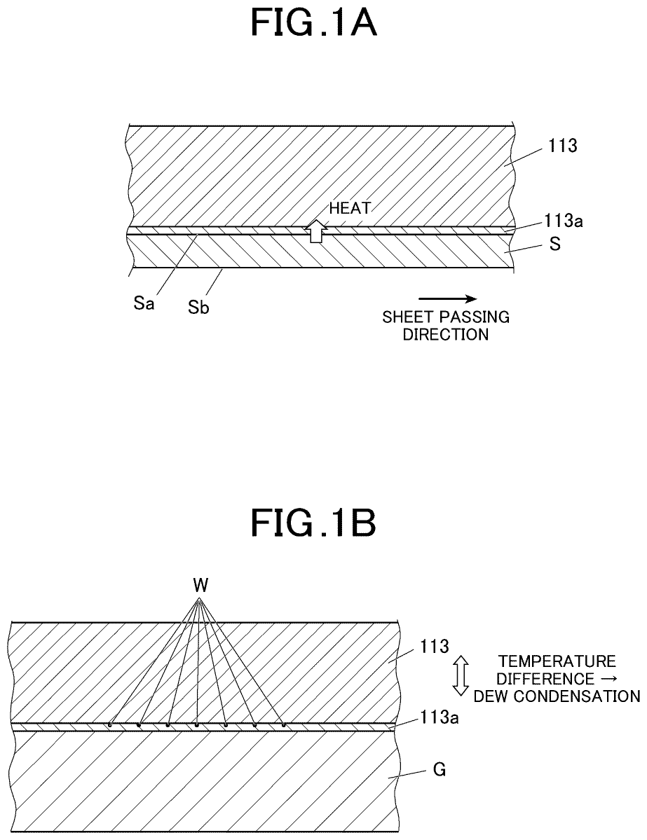

FIG. 1A and FIG. 1B are schematic sectional views of a guide and a sheet S in a case where the guide that conveys a recording medium (sheets S) is formed of a sheet metal 113. FIG. 1A illustrates the state of the guide during passage of the sheet S, and FIG. 1B illustrates the state of the guide after the passage of the sheet S.

As illustrated in FIG. 1A, the sheet S having a high temperature after fixing contacts the sheet metal 113 having a low temperature, and thus, as illustrated in FIG. 1B, temperatures of a front face 113a of the sheet metal 113 and the surrounding air G increase after the sheet passes therethrough. At the time, the front 113a of the sheet metal 113 is rapidly deprived of heat, so that the temperature difference occurs between the cooled sheet metal 113 and the warmed air G. As a result, dew condensation W occurs on the front face 113a of the sheet metal 113.

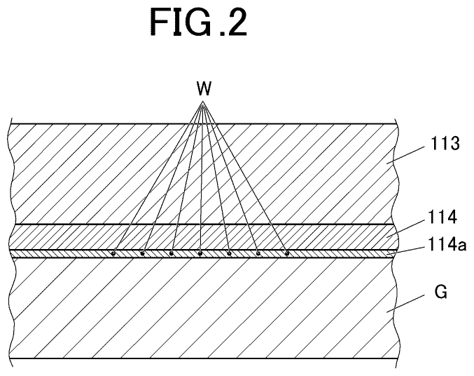

FIG. 2 is a schematic sectional view of the guide and the sheet S in the case where a resin sheet 114 having a lower thermal conductivity than that of the sheet metal 113 is disposed on the conveyance face of the guide, which conveys the sheet S. FIG. 2 illustrates the state of the guide after the passage of the sheet S.

As compared with the guide made of the sheet metal 113 as illustrated in FIG. 1A, the low-thermal-conductivity resin sheet 114 disposed on the sheet metal 113 as illustrated in FIG. 2 can suppress a rapid temperature change. Therefore, the speed at which the sheet metal 113 is deprived of heat can be reduced, and dew condensation is less likely to occur.

However, when the fixing temperature is further increased in order to improve the image fixability, the temperature of the sheet S also further increases, and it is not possible to cope with this only by providing the low-thermal-conductivity resin sheet 114 to slow down the speed at which the sheet metal 113 is deprived of heat. Therefore, the temperatures of the front face 114a of the resin sheet 114 and the surrounding air G increase, the temperature difference occurs between the cooled sheet metal 113 and the warmed air G, and the dew condensation W occurs.

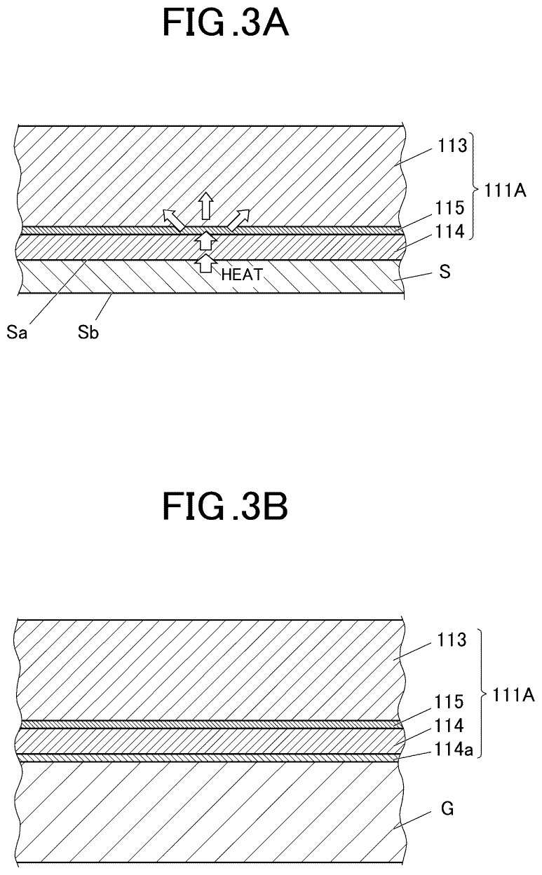

Therefore, in the present invention, as illustrated in FIG. 3A, a high-thermal-conductivity sheet 115 is disposed between the sheet metal 113 and the low-thermal-conductivity resin sheet 114. FIG. 3A and FIG. 3B are schematic sectional views of a first guide 111A and the sheet S of the present invention. FIG. 3A illustrates the state of the first guide 111A during passage of the sheet S, and FIG. 3B illustrates the state thereof after the passage of the sheet S.

As in the present invention, by configuring the first guide 111A with the resin sheet 114, the high-thermal-conductivity sheet 115, and the sheet metal 113 in this order from the conveyance face side, even if the surrounding air G is warmed by the high-temperature sheet S, the high-thermal-conductivity sheet 115 disperses the heat to the surroundings, as illustrated in FIG. 3A. Therefore, as illustrated in FIG. 3B, after the sheet S passes, the temperature increase of the resin sheet 114 itself can be suppressed, and the temperature increase of the air G heated by the resin sheet 114 can also be suppressed. By suppressing the temperature increase of the air G, the temperature difference is less likely to occur between the resin sheet 114 and the air G when the resin sheet 114 is cooled by the sheet metal 113, thus preventing dew condensation. As a result, transfer failure due to dew condensation can be prevented when transfer is performed in double-sided printing.

Hereinafter, embodiments of the present invention will be described with reference to the drawings. The advantages and features provided by the embodiments will be understood from the following detailed description and the drawings. However, the scope of the present invention is not limited to the embodiments disclosed below or the examples illustrated in the drawings.

The conveyance device according to the present invention is a conveyance device conveying a recording medium with an image fixed by a fixer, the conveyance device including a first guide disposed on the downstream side of the fixer and including: a sheet metal; a resin sheet disposed over a conveyance face of the sheet metal; and a high-thermal-conductivity sheet disposed between the sheet metal and the resin sheet and having a higher thermal conductivity than the thermal conductivity of the sheet metal.

The above-described features are technical features common to or corresponding to embodiments below.

As an embodiment of the present invention, preferably, the high-thermal-conductivity sheet is disposed so as to face a non-image face of the recording medium with the resin sheet in between. Thus, in a recording medium on which printing is to be performed in double-sided printing, influence of dews on the non-image face can be prevented, which surely prevents transfer failure.

Preferably, the conveyance device includes a second guide disposed on the upstream side of the first guide and the downstream side of the fixer and made of a material having a thermal conductivity lower than the thermal conductivity of the sheet metal. Thus, it is possible to reliably prevent dew condensation from occurring on the second guide that first contacts the sheet heated by fixing.

Preferably, the conveyance device includes a third guide disposed on the downstream side of the first guide and made of a sheet metal, wherein the sheet metal of the third guide and a non-image face of the recording medium come in direct contact with one another. Since the sheet is gradually cooled as it is conveyed to the downstream side, dew condensation is less likely to occur at the third guide. Therefore, a sheet metal can be used for the third guide where dew condensation is unlikely to occur, and thus the cost can be reduced, and the third guide can be manufactured with high accuracy.

Preferably, the thickness of the high-thermal-conductivity sheet is less than the thickness of the sheet metal and the resin sheet of the first guide. Especially preferably, the thickness of the high-thermal-conductivity sheet is less than 0.1 mm. Thus, the recording medium can be smoothly conveyed without the conveyance path of the recording medium being narrowed. In addition, since the high-thermal-conductivity sheet is intended to disperse the heat of the resin sheet, its function can be sufficiently carried out even when its thickness is small.

Preferably, the high-thermal-conductivity sheet is made of aluminum from the viewpoint of being able to be easily processed to be thin.

Preferably, the resin sheet is made of high-density polyethylene from the viewpoint of durability and thermal conductivity.

Preferably, the high-thermal-conductivity sheet is disposed on the entirety of a face of the resin sheet, the face being opposite to a conveyance face of the resin sheet, from the viewpoint that dew condensation can be reliably prevented.

Preferably, the resin sheet and the high-thermal-conductivity sheet cover the entire area of the recording medium in a width direction thereof. Since the entire area of the recording medium in the width direction is covered with the resin sheet and the high-thermal-conductivity sheet, there is no point where the sheet metal and the recording medium directly contact each other, and thus it is possible to reliably prevent dew condensation.

Preferably, the resin sheet and the high-thermal-conductivity sheet each are divided in the width direction of the recording medium. This makes the assembly work to provide the resin sheet and the high-thermal-conductivity sheet over/on the sheet metal easy.

The image forming apparatus according to the present invention is an image forming apparatus including: an image former forming an image on a recording medium; a fixer fixing the image on the recording medium; and the conveyance device conveying the recording medium with the image fixed. Thus, even when the fixing temperature is increased, the temperature increase of the surrounding air after fixing can be suppressed, and dew condensation in the conveyance device can be prevented. As a result, it is possible to prevent transfer failure in double-sided printing.

Hereinafter, the present invention and constituent elements thereof, and modes/aspects for carrying out the present invention will be described. In the present specification, numerical values before and after “to” are included in a range as the lower limit value and the upper limit value.

### [Conveyance Device]

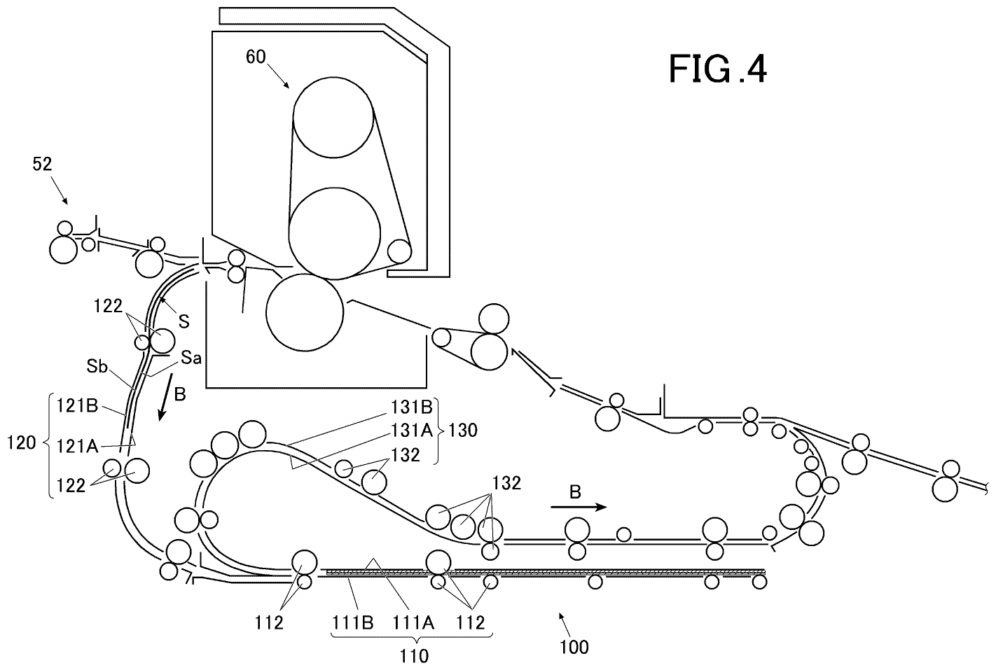

FIG. 4 is a schematic diagram illustrating the configuration of the conveyance device.

A conveyance device 100 is a device that conveys a recording medium on which an image has been fixed by a fixing section 60 (fixer). The conveyance device 100 is preferably a device that conveys a recording medium for further forming and fixing an image on the back face of the recording medium after an image is formed and fixed on the front face of the recording medium.

The recording medium is preferably, for example, a sheet S such as a standard sheet and a special sheet, a resin film such as polyethylene terephthalate, a magnetic card, or the like.

The conveyance device 100 includes a first conveyance section 110 (first conveyor), a second conveyance section 120 (second conveyor), and a third conveyance section 130 (third conveyor).

The first conveyance section 110 is disposed on the downstream side of the fixing section 60 in the conveyance direction. In FIG. 4, the direction of an arrow B is the conveyance direction.

The first conveyance section 110 temporarily stops the sheet S conveyed from the second conveyance section 120, reverses the conveyance direction B, and conveys the sheet S to the third conveyance section 130. That is, the first conveyance section 110 functions as a switchback path.

The second conveyance section 120 is disposed on the upstream side of the first conveyance section 110 in the conveyance direction and on the downstream side of the fixing section 60 and conveys the sheet S from the fixing section 60 to the first conveyance section 110.

The third conveyance section 130 is disposed on the downstream side of the first conveyance section 110 in the conveyance direction and conveys the sheet S from the first conveyance section 110 to an image forming section. That is, the third conveyance section 130 functions as a back face conveyance path by the sheet S being switched back in the first conveyance section 110.

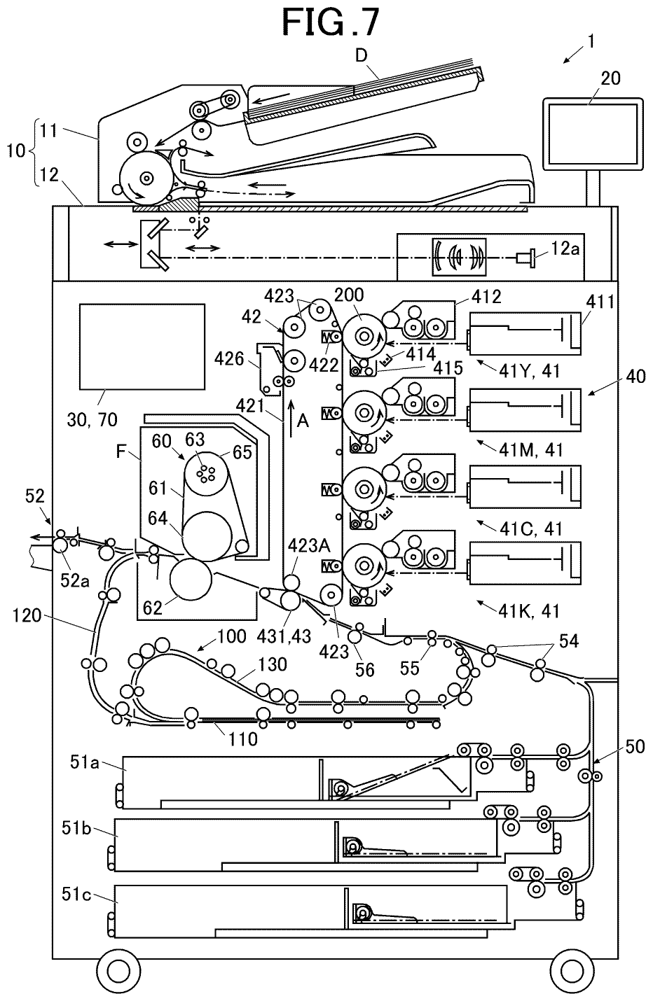

The image forming section is, for example, an image forming section 40 (image former) included in an image forming apparatus 1 of FIG. 7 described later. The image forming section is not illustrated in FIG. 4 for the convenience of the drawing.

Therefore, the first to third conveyance sections 110 to 130 are arranged in the order of the second conveyance section 120, the first conveyance section 110, and the third conveyance section 130 from the fixing section 60 along the conveyance direction.

The conveyance direction of the sheet S conveyed from the second conveyance section 120 to the first conveyance section 110 is reversed, and the sheet S is conveyed in the third conveyance section 130 in the state in which the back face of the sheet S is the image formation face.

### <Second Conveyance Section>

The second conveyance section 120 includes a pair of second guides 121A and 121B that receive the sheet S on which an image has been fixed by the fixing section 60 and a plurality of pairs of conveyance rollers 122 that sandwich and convey the received sheet S. The second conveyance section 120 conveys the sheet S with an image fixed by the fixing section 60 to the first conveyance section 110 on the downstream side at a predetermined conveyance speed.

The second guides 121A and 121B are disposed to face each other, and a space between the second guides 121A and 121B is the conveyance path for conveying the sheet S.

The pairs of conveyance rollers 122 are exposed from unillustrated cutout portions formed at predetermined positions of the second guides 121A and 121B so as to be rotatable.

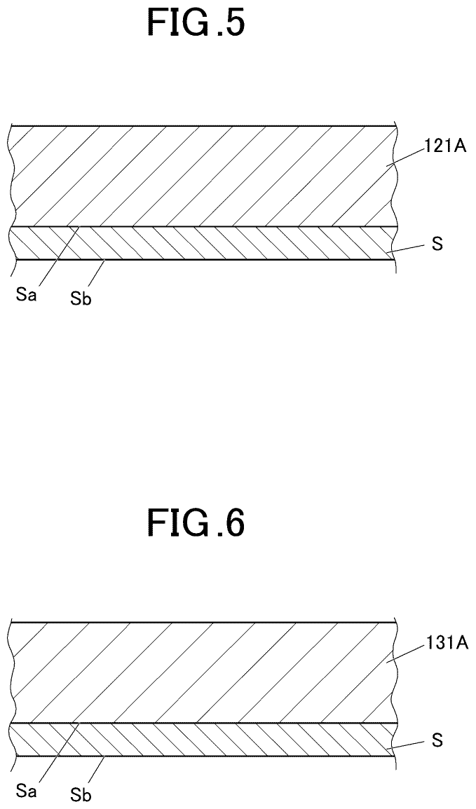

FIG. 5 is a schematic sectional view of the second guide 121A and the sheet S.

Of the second guides 121A and 121B, the second guide 121A that supports the non-image face Sa of the sheet S is formed of a material having a lower thermal conductivity than that of the sheet metal.

It is preferable that the second guide 121B (see FIG. 4) supporting the image face Sb of the sheet S is also formed of the material having a lower thermal conductivity than that of the sheet metal.

Examples of the material having a lower thermal conductivity than that of the sheet metal include resin. Examples of the resin include polycarbonate and ABS resin.

The thermal conductivity of the sheet metal is in a range of 30 to 80 W/mK, and the thermal conductivity of the second guide 121A is preferably 1 W/mK or less.

It is preferable that the pairs of conveyance rollers 122 are formed of ethylene-propylene rubber or the like. The thermal conductivity of ethylene-propylene rubber is 1 W/mK or less.

### <First Conveyance Section>

The first conveyance section 110 includes a pair of first guides 111A and 111B that receive the sheet S conveyed from the second conveyance section 120 and a plurality of pairs of rollers 112 that sandwich and convey the received sheet S. The first conveyance section 110 reverses the conveyance direction of the sheet S received from the second conveyance section 120 and conveys the sheet S to the third conveyance section 130 on the downstream side at a predetermined conveyance speed.

The first guides 111A and 111B are disposed to face each other, and a space between the first guides 111A and 111B is the conveyance path for conveying the sheet S.

As illustrated in FIG. 3A, of the first guides 111A and 111B, the first guide 111A that supports the non-image face Sa of the sheet S includes the sheet metal 113 and the resin sheet 114 disposed on, of both faces of the sheet metal 113, the conveyance face.

The high-thermal-conductivity sheet 115 having a higher thermal conductivity than that of the sheet metal 113 is disposed between the sheet metal 113 and the resin sheet 114. Accordingly, the high-thermal-conductivity sheet 115 is disposed to face the non-image face Sa of the sheet S with the resin sheet 114 in between.

The material of the first guide 111B (see FIG. 4) that supports the image face Sb of the sheet S is not particularly limited, and may be a sheet metal, may have a three-layer structure of a sheet metal, a high-thermal-conductivity sheet and a resin sheet as with the first guide 111A, or may have a two-layer structure of a sheet metal and a resin sheet.

The sheet metal 113 is formed of, for example, plain steel (SPCC or SPHC), hot-dip galvanized steel (SGCC), or the like. Here, SPCC is a cold-rolled steel sheet, and SPHC is a hot-rolled steel sheet. The thermal conductivity of the sheet metal 113 formed of the metal plate or the like is preferably within a range of 30 to 80 W/mK as described above.

The high-thermal-conductivity sheet 115 preferably has a higher thermal conductivity than that of the sheet metal 113 and in a range of 150 to 300 W/mK. The high-thermal-conductivity sheet 115 is made of, for example, aluminum (thermal conductivity: 237 W/mK), cupper (thermal conductivity: 403 W/mK), silver (thermal conductivity: 428 W/mK), or the like, and is preferably made of aluminum from the viewpoint of inexpensiveness.

The thermal conductivity of the resin sheet 114 is preferably lower than that of the sheet metal 113 and equal to or lower than 1 W/mK. The resin sheet 114 is preferably made of, for example, high-density polyethylene, polytetrafluoroethylene (PTFE), or the like.

Polyethylene is classified into the following 1) to 3) types depending on the density.
1) Low-density polyethylene (LDPE): density of 0.910 g/cm³ or more and less than 0.930 g/cm³
2) Medium-density polyethylene (MDPE): density of 0.930 g/cm³ or more and less than 0.942 g/cm³
3) High-density polyethylene (HDPE: density of 0.942 g/cm³ or more

The resin sheet 114 according to the present invention is preferably made of high-density polyethylene having a density of 0.942 g/cm³ or more (above 3))

The high-thermal-conductivity sheet 115 is preferably thinner than each of the sheet metal 113 and the resin sheet 114. It is especially preferable that the high-thermal-conductivity sheet 115 is thinner than 0.1 mm. When the high-thermal-conductivity sheet 115 is thin, the conveyance path is not narrowed, and the sheet S can be smoothly conveyed. In addition, since the high-thermal-conductivity sheet 115 is intended to disperse the heat of the resin sheet 114, its function can be sufficiently carried out even when its thickness is small.

The thicknesses of the sheet metal 113 is preferably within a range of 0.8 to 2.0 mm.

The thickness of the resin sheet 114 is preferably within a range of 0.05 to 0.5 mm from the viewpoint of smooth conveyance without the conveyance path being excessively filled with the resin sheet, and moderation of the thermal conduction.

The high-thermal-conductivity sheet 115 is preferably disposed on the entirety of the face (entire back face) of the resin sheet 114 opposite to the conveyance face from the viewpoint that dew condensation can be reliably prevented.

Furthermore, it is preferable that the resin sheet 114 and the high-thermal-conductivity sheet 115 cover the entire area of the sheet S in the width direction. Since the entire area of the sheet S in the width direction is covered with the resin sheet 114 and the high-thermal-conductivity sheet 115, there is no point where the sheet metal 113 and the sheet S directly contact each other, and thus dew condensation can be reliably prevented.

Furthermore, it is preferable that the high-thermal-conductivity sheet 115 be divided in the width direction of the sheet S to make the attachment work to the sheet metal 113 easy. The high-thermal-conductivity sheet 115 is preferably bonded to the sheet metal 113 with an adhesive or the like.

Similarly, it is preferable that the resin sheet 114 be also divided in the width direction of the sheet S from the viewpoint of the easiness of the attachment work. The resin sheet 114 is preferably adhered to the high-thermal-conductivity sheet 115 with an adhesive or the like.

The pairs of conveyance rollers 112 are preferably formed of ethylene-propylene rubber or the like.

### <Third Conveyance Section>

The third conveyance section 130 includes a pair of third guides 131A and 131B that receive the sheet S conveyed from the first conveyance section 110 and a plurality of pairs of conveyance rollers 132 that sandwich and convey the received sheet S. The third conveyance section 130 conveys the sheet S received from the first conveyance section 110 to the image forming section (image forming section 40 in FIG. 5) on the downstream side at a predetermined conveyance speed for double-sided printing.

The third guides 131A and 131B are disposed to face each other, and a space between the third guides 131A and 131B is the conveyance path for conveying the sheet S.

FIG. 6 is a schematic sectional view of the third guide 131A and the sheet S.

Of the third guides 131A and 131B, the third guide 131A that supports the non-image face Sa of the sheet S is preferably made of a sheet metal. Thus, the non-image face Sa of the sheet S comes into direct contact with the sheet metal.

The material of the third guide 131B (see FIG. 4) supporting the image face Sb of the sheet S is not particularly limited, but it is preferable that the third guide 131B be formed of a sheet metal as with the third guide 131A in terms of inexpensiveness.

Similarly to the sheet metals 131A and 131B of the first conveyance section 110, the sheet metals used for the third guides 111A and 111B are each formed of a metal plate such as plain steel (SPCC or SPHC) and hot-dip galvanized steel (SGCC).

The pairs of conveyance rollers 132 are preferably formed of ethylene-propylene rubber or the like.

According to the conveyance device 100 thus configured, the sheet S with an image fixed by the fixing section 60 is conveyed with the non-image face Sa supported by the second guide 121A of the second conveyance section 120. The second guide 121A that first comes into contact with the sheet S heated by the fixing section 60 is prone to dew condensation, but since the second guide 121A is formed of a low-thermal-conductivity material, dew condensation does not occur.

Next, the sheet S is conveyed with the non-image face Sa supported by the first guide 111A of the first conveyance section 110. Since the first guide 111A has the three-layer structure of the sheet metal 113, the high-thermal-conductivity sheet 115 and the resin sheet 114, even if the surrounding air is warmed by the high-temperature sheet, the high-thermal-conductivity sheet 115 dissipates the heat to the surroundings. Therefore, the temperature increase of the resin sheet 114 itself after the passage of the sheet S can be suppressed, and the temperature increase of the air G heated by the resin sheet 114 can also be suppressed. By suppressing the temperature increase of the air G, the temperature difference is less likely to occur between the resin sheet 114 and the air G when the resin sheet 114 is cooled by the sheet metal 113, thus preventing dew condensation.

Furthermore, the sheet S is conveyed from the second conveyance section 120 with the non-image face Sa supported by the third guide 131A of the third conveyance section 130. Although the third guide 131A is formed of a sheet metal, the temperature of the sheet S is also lowered when the sheet S is conveyed by the third guide 131A. Therefore, dew condensation due to the difference in temperature from the sheet metal of the third guide 131A does not occur. Therefore, it is possible to prevent transfer failure in double-sided printing due to the dew condensation.

### [Image Forming Apparatus]

Next, an image forming apparatus including the conveyance device will be described.

FIG. 7 is a schematic diagram illustrating the configuration of the image forming apparatus including the conveyance device. As illustrated in FIG. 7, an image forming apparatus 1 is an electrophotographic image forming apparatus.

The image forming apparatus 1 includes an image reading section 10, an operation-display part 20, an image processing section 30, an image forming section 40, a sheet feed section 50, a sheet ejection section 52, a conveyance device 100, a fixing section 60, and a controller 70.

The controller 70 is a device for centrally controlling the operation of each block of the image forming apparatus 1 in cooperation with expanded programs. The controller 70 includes, for example, a central processing unit (CPU), a read only memory (ROM), and a random access memory (RAM).

The image reading section 10 includes an auto document feed device 11 called an auto document feeder (ADF), a document image scanning device 12 (scanner), and the like.

The operation-display part 20 is constituted by, for example, a liquid crystal display (LCD) provided with a touch screen, and functions as a display part and an operation part.

The image processing section 30 includes a circuit that performs digital image processing on input image data in accordance with initial settings or user settings.

The image forming section 40 includes an image forming unit 41 for forming images with color toners of a Y component, an M component, a C component and a K component on the basis of the input image data, an intermediate transfer unit 42, and a secondary transfer unit 43.

The image forming unit 41 includes four image forming units 41Y, 41M, 41C and 41K for the Y component, the M component, the C component and the K component. The image forming units 41Y, 41M, 41C and 41K have the same configuration, and therefore, for the convenience of illustration and explanation, common constituent elements are denoted by the same reference sign, and Y, M, C or K is added to the reference sign in a case of distinguishing the image forming units from one another.

In FIG. 7, reference signs are provided to the constituent elements of the image forming unit 41Y for the Y component only, and the reference signs of the constituent elements of the other image forming units 41M, 41C and 41K are omitted.

The image forming unit 41 includes an exposure device 411, a developing device 412, a photoreceptor 200, a charging device 414, and a drum cleaning device 415.

The photoreceptor 200 is an electrophotographic photoreceptor. The photoreceptor 200 is a negatively charged organic photoconductor (OPC) including a conductive substrate, an undercoat layer (UCL), a charge generating layer (CGL), a charge transport layer (CTL), and an overcoat layer (OCL).

The charging device 414 is a non-contact charging device using, for example, corona discharge. The charging device 414 may be a contact charging device that charges the photoreceptor 200 by contacting the photoreceptor 200.

The exposure device 411 is constituted by, for example, a semiconductor laser.

The developing device 412 is a developing device for two-component developer and contains a developer of one of the color components. Examples of the developer include a two-component developer composed of a toner having a small particle diameter and a magnetic material.

The drum cleaning device 415 includes a drum cleaning blade, such as an elastic blade, disposed so as to be slidable on the face of the photoreceptor 200.

The intermediate transfer unit 42 includes an intermediate transfer belt 421, primary transfer rollers 422, support rollers 423 including a backup roller 423A, and a belt cleaning device 426.

The intermediate transfer belt 421 is constituted by an endless belt and stretched in a loop around the plurality of support rollers 423. At least one of the support rollers 423 is constituted by a drive roller, and the others are constituted by driven rollers.

The belt cleaning device 426 includes a belt cleaning blade, such as an elastic blade, disposed so as to be slidable on the face of the intermediate transfer belt 421.

The secondary transfer unit 43 includes, for example, a secondary transfer roller 431. The secondary transfer unit 43 may have a configuration in which a secondary transfer belt is stretched in a loop around a plurality of support rollers including the secondary transfer roller.

The fixing section 60 is disposed as a unit in a fixing device F. The fixing section 60 includes an endless fixing belt 61, two rollers 64 and 65 for endlessly supporting the fixing belt 61, a heating device 63 for heating the fixing belt 61 supported by the rollers 64 and 65, and a pressure roller 62 disposed so as to be biased relative to the roller 64.

The roller 64 is disposed to face the pressure roller 62 with the fixing belt 61 in between and has a roller diameter of 50 mm or more. The rollers 64 and 65 support the fixing belt 61 on an endless track with a tensile force of 45N. For example, the roller 64 is a drive roller and the roller 65 is a driven roller.

The heating device 63 includes, for example, a halogen lamp or a resistance heating element, and is built in the roller 65.

The pressure roller 62 is disposed so as to be able to approach and separate from the roller 64. The pressure roller 62 comes into pressure contact with the fixing belt 61 supported by the roller 64, so that a fixing nip part for nipping and conveying the sheet S is formed.

As the heating device 63, a heating device using an induction heating (IH) method may be adopted. An air separation unit that separates the sheet S from the fixing belt 61 or the pressure roller 62 by blowing air may be further disposed in the fixing device F.

The sheet feed section 50 includes three sheet feed tray units 51a to 51c and a plurality of roller sections including an intermediate conveyance roller section 54, a loop roller section 55 and a registration roller section 56. In the sheet feed tray units 51a to 51c, sheets S identified on the basis of their basis weights, sizes and/or the like are housed by type, the types being preset.

The sheet ejection section 52 conveys the sheets S to the outside of the image forming apparatus 1.

The conveyance device 100 is the above-described conveyance device 100 illustrated in FIG. 4, and includes the first to third conveyance sections 110 to 130 serving as the conveyance path in double-sided printing. The description of the conveyance device 100 will be omitted.

In the image forming apparatus 1, the auto document feed device 11 conveys a document D placed on a document tray with a conveyance mechanism to send out the document to the document image scanning device 12. The auto document feed device 11 can continuously and collectively read images (including images on both faces) of a large number of documents D placed on the document tray.

The document image scanning device 12 optically scans the document conveyed from the auto document feed device 11 onto a contact glass or a document placed on the contact glass, forms an image of light reflected by the document on a light receiving face of a charge-coupled device (CCD) sensor 12a to read a document image.

The image reading section 10 generates input image data based on the result of reading by the document image scanning device 12. The input image data undergoes predetermined image processing as necessary in the image processing section 30.

The controller 70 controls drive current supplied to a drive motor (not illustrated) that rotates the photoreceptor 200. Thus, the photoreceptor 200 rotates at a constant circumferential speed. The charging device 414 uniformly and negatively charges the face of the photoreceptor 200 having photoconductivity. The exposure device 411 irradiates the photoreceptor 200 with laser light corresponding to an image of a color component, and an electrostatic latent image of the color component is formed on the face of the photoreceptor 200 due to the potential difference from the surroundings. The developing device 412 forms a toner image by visualizing the electrostatic latent image by adhering the toner of the color component to the face of the photoreceptor 200.

The rotation of the support roller 423 serving as a drive roller causes the intermediate transfer belt 421 to run in the direction of an arrow A at a constant speed. The intermediate transfer belt 421 is brought into pressure contact with the photoreceptor 200 by the primary transfer roller 422, so that a primary transfer nip part is formed, and the toner images of the respective colors on the respective photoreceptors 200 are primarily transferred onto the intermediate transfer belt 421 so that the toner images of the respective colors are sequentially superimposed. The transfer residual toner remaining on the face of the photoreceptor 200 after the primary transfer is removed from the face by the elastic blade in the drum cleaning device 415, the elastic blade being in contact with the face of the photoreceptor 200.

The secondary transfer roller 431 is pressed against the backup roller 423A with the intermediate transfer belt 421 in between, so that a secondary transfer nip part is formed. The sheet S fed from the sheet feed section 51 or the conveyance device 100 is conveyed to the secondary transfer nip part. The inclination and the position in the width direction (deviation) of the sheet S are corrected in the process of the sheet S being conveyed by the roller sections including the intermediate conveyance roller section 54, the loop roller section 55 and the registration roller section 56.

When the sheet S passes through the secondary transfer nip part, the toner image borne on the intermediate transfer belt 421 is secondarily transferred onto the sheet S. The sheet S on which the toner image has been transferred is conveyed toward the fixing section 60. The transfer residual toner remaining on the face of the intermediate transfer belt 421 after the secondary transfer is removed from the face by the elastic blade in the belt cleaning device 426, the elastic blade being in contact with the face of the intermediate transfer belt 421.

The fixing section 60 heats and pressurizes the conveyed sheet S at the fixing nip part, thereby fixing the toner image on the sheet S. The drive control of the fixing belt 61, the pressure roller 62, the heating device 63 and the like is performed by the controller 70.

The fixing belt 61 is heated by the heating device 63, and as a result, the temperature of the fixing belt 61 becomes uniform in the width direction at a predetermined fixing temperature (e.g., 170° C.). The fixing temperature is a temperature at which thermal energy required for melting the toner on the sheet S can be supplied, and varies depending on the sheet type of the sheet S on which an image is formed.

In the case of double-sided printing, the conveyance device 100 once conveys the sheet S to the first conveyance section 110, which is the switchback path, then causes the sheet S to switch back and conveys the sheet S to the third conveyance section 130, which is the back face conveyance path, thereby reversing the sheet S and supplying the sheet S to the upstream side of the loop roller section 55. Then, the sheet S is again supplied to the secondary transfer nip part so that a desired toner image is transferred onto the sheet S, and then the toner image is fixed onto the sheet S in the fixing section 60.

Thus, the sheet S with the desired image formed is ejected to the outside of the image forming apparatus 1 by the sheet ejection section 52 having a sheet ejection roller 52a.

Those described in the above embodiment(s) are not limitations but examples of the conveyance device and the image forming apparatus of the present invention. The detailed configuration and detailed operation of each component constituting the apparatus can be appropriately changed without departing from the scope of the present invention.

For example, in the above-described embodiment(s), the conveyance device of the present invention is disposed in the image forming apparatus as the conveyance device that conveys the sheet after fixing for double-sided printing, but not limited thereto. The conveyance device of the present invention may be provided as a conveyance device that ejects the sheet after fixing to the outside of the image forming apparatus as it is.

### EXAMPLES

Hereinafter, the present invention will be specifically described with reference to Examples, but the present invention is not limited thereto. Note that in the following Examples, operation was performed at room temperature (25° C.) unless otherwise specified.

In order to confirm the effects in the case where the first guide is provided with an aluminum sheet, a first guide [1] and a first guide [2] of two levels described below were prepared.

### First Guide [1](Comparative Example)

A high-density polyethylene sheet was attached to the face of a sheet metal to produce the first guide [1]. Plain steel (SPCC) was used as the sheet metal.

### First Guide [2](Present Invention)

An aluminum sheet was attached to the face of a sheet metal and a high-density polyethylene sheet was attached to the aluminum sheet to produce the first guide [2]. Plain steel (SPCC) was used as the sheet metal.

### <Evaluation of Transferability>

Each of the produced first guides was attached to a production printing machine, and the transferability was evaluated under the following conditions.

### (Operating Environment)

The production printing machine was used after left in an environment of a temperature of 10° C. and a humidity of 20% for 24 hours or more in order that dew condensation could easily occur.

Every time one condition data was collected, the temperature of the sheet metal at which occurrence of failure was expected was measured and, after it was confirmed that the temperature reached 10 degrees, the next condition was carried out.

### (Sheet Used)

Sheets left in an opened state in an environment of a temperature of 30° C. and a humidity of 80% for 48 hours or more until immediately before use were used in order that dew condensation could easily occur.

To be specific, for the sheets, POD gloss coat 128 g was selected as generally recommended sheets of paper, and as a sheet size, a relatively large SRA3 size among standard sizes, which exclude non-standard sizes, was selected in order to increase the detection accuracy of failure in the width direction of the sheets.

### (Image Condition)

A two-layer image with a coverage rate of 100% was selected as an image condition under which failure was likely to occur. For the two-layer image, magenta was 100% and cyan was 100%.

### (Number of Printed Sheets)

Printing was performed on 20 sheets by continuous double-sided printing, and sheets with transfer failure were counted.

### (Repetition Condition)

In order to clearly show the effects, the case of using the first guide [1] and the case of using the first guide [2] were alternately performed three times each.

TABLE 1

| FIRST | | TRANSFER FAILURE | | | |
|---|---|---|---|---|---|
| GUIDE | | FIRST | SECOND | THIRD | |
| NO. | STRUCTURE | TIME | TIME | TIME | REMARKS |
| [1] | SHEET METAL + | 4/20 | 9/20 | 8/20 | COMPARATIVE |
| | HIGH-DENSITY PE | SHEETS | SHEETS | SHEETS | EXAMPLE |
| [2] | SHEET METAL + AL + | 0/20 | 0/20 | 0/20 | PRESENT |
| | HIGH-DENSITY PE | SHEETS | SHEETS | SHEETS | INVENTION |

As shown in the above, it is recognized that no transfer failure occurred in the case of the first guide of the present invention, in which the aluminum sheet was disposed between the sheet metal and the high-density polyethylene sheet. On the other hand, transfer failure occurred in the case of the first guide of the comparative example, which was made of the sheet metal and the high-density polyethylene sheet.

Although embodiments of the present invention have been described and illustrated in detail, the disclosed embodiments are made for purposes of illustration and example only and not limitation. The scope of the present invention should be interpreted by terms of the appended claims.

What is claimed is:

1. A conveyance device conveying a recording medium with an image fixed by a fixer, the conveyance device comprising a first guide disposed on a downstream side of the fixer and including:
a sheet metal;
a resin sheet disposed over a conveyance face of the sheet metal; and
a high-thermal-conductivity sheet disposed between the sheet metal and the resin sheet and having a higher thermal conductivity than a thermal conductivity of the sheet metal.

2. The conveyance device according to claim 1, wherein the high-thermal-conductivity sheet is disposed so as to face a non-image face of the recording medium with the resin sheet in between.

3. The conveyance device according to claim 1, comprising a second guide disposed on an upstream side of the first guide and the downstream side of the fixer and made of a material having a thermal conductivity lower than the thermal conductivity of the sheet metal.

4. The conveyance device according to claim 1, comprising a third guide disposed on a downstream side of the first guide and made of a sheet metal,
wherein the sheet metal of the third guide and a non-image face of the recording medium come in direct contact with one another.

5. The conveyance device according to claim 1, wherein a thickness of the high-thermal-conductivity sheet is less than a thickness of the sheet metal and the resin sheet of the first guide.

6. The conveyance device according to claim 5, wherein the thickness of the high-thermal-conductivity sheet is less than 0.1 mm.

7. The conveyance device according to claim 1, wherein the high-thermal-conductivity sheet is made of aluminum.

8. The conveyance device according to claim 1, wherein the resin sheet is made of high-density polyethylene.

9. The conveyance device according to claim 1, wherein the high-thermal-conductivity sheet is disposed on entirety of a face of the resin sheet, the face being opposite to a conveyance face of the resin sheet.

10. The conveyance device according to claim 1, wherein the resin sheet and the high-thermal-conductivity sheet cover an entire area of the recording medium in a width direction thereof.

11. The conveyance device according to claim 1, wherein the resin sheet and the high-thermal-conductivity sheet each are divided in a width direction of the recording medium.

12. An image forming apparatus comprising:
an image former forming an image on a recording medium;
a fixer fixing the image on the recording medium; and
the conveyance device according to claim 1, the conveyance device conveying the recording medium with the image fixed.
